(19) United States
(12) Patent Application Publication
(10) Pub. No.: US 2022/0092626 A1
(43) Pub. Date: Mar. 24, 2022

(54) COMMODITY PURCHASE SYSTEM, RELAY SERVER, AND REGISTRATION DEVICE

(71) Applicant: TOSHIBA TEC KABUSHIKI KAISHA, Tokyo (JP)

(72) Inventors: Takahiro MIKI, Yokohama Kanagawa (JP); Atsushi NAKAMOTO, Kawasaki Kanagawa (JP)

(21) Appl. No.: 17/408,162

(22) Filed: Aug. 20, 2021

(30) Foreign Application Priority Data
Sep. 24, 2020 (JP) 2020-159727

(51) Int. Cl. G06Q 30/02; G06Q 20/08

(52) U.S. Cl. CPC G06Q 30/0222; G06Q 20/085

(57) ABSTRACT

A commodity purchase system for assisting a customer not at a store in making purchase, includes a first terminal configured to capture an image of commodities in the store, a server configured to acquire commodity information about one of the commodities, and a second terminal configured to display the information and issue a request for purchase of said one of the commodities, and issue a settlement request for settling purchase of commodities purchased by the customer. The server is further configured to, upon issuance of the settlement request, cause the first terminal to output a screen through which a delivery method of the purchased commodities can be selected, calculate the payment amount and a reward for a user of the first terminal based on the selected delivery method, and perform settlement processing based on the payment amount and output reward information indicating the reward.

### CROSS-REFERENCE TO RELATED APPLICATION

This application is based upon and claims the benefit of priority from Japanese Patent Application No. 2020-159727, filed Sep. 24, 2020, the entire contents of which are incorporated herein by reference.

### FIELD

Embodiments described herein relate generally to a commodity purchase system, a relay server, and a registration device.

### BACKGROUND

It may be difficult for an aged person or the like to go to a store for shopping by himself or herself because of his or her health conditions. It may also be difficult for a person living in a remote place to go to a store for shopping. Such an aged person or a person living in the remote place (hereinafter referred to as “a requester”) needs to ask another person such as an acquaintance or a family member to purchase, on behalf of the requester, commodities that the requester desires to purchase.

However, since the requester cannot be in the store during the purchase, he or she is not given a chance to select and purchase additional commodities (e.g., impulse purchases) other than the originally requested commodities.

In view of such circumstances, there have been demands for a system with which, even if a requester is not physically present in a store, the requester can still select and purchase commodities as if the requester is actually doing shopping in the store.

### BRIEF DESCRIPTION OF THE DRAWINGS

FIG. 1 is a schematic block diagram of a commodity purchase system according to an embodiment.

FIG. 2 is a hardware block diagram of a requester terminal or a visitor terminal according to an embodiment.

FIG. 3 is a hardware block diagram of a relay server.

FIG. 4 depicts a data structure of a data record included in a member database.

FIG. 5 depicts a data structure of a data record included in a store database.

FIG. 6 depicts a data structure of a charge table.

FIG. 7 depicts a data structure of a data record included in a transaction management database.

FIG. 8 is a hardware block diagram of a registration device according to an embodiment.

FIG. 9 is a flowchart of information processing performed by a requester terminal.

FIG. 10 and FIG. 11 are flowcharts of information processing performed by a relay server.

FIG. 12 is a flowchart of coupon information generation processing.

FIG. 13 is a flowchart of information processing performed by a visitor terminal.

FIG. 14 is a flowchart of information processing performed by a registration device.

FIG. 15 is a flowchart of information processing performed by a registration device.

FIG. 16 depicts a streaming screen displayed by a requester terminal and a visitor terminal.

FIG. 17 depicts a registration screen displayed by a visitor terminal.

FIG. 18 depicts a re-scan request screen displayed by a visitor terminal.

FIG. 19 depicts a delivery method selection screen displayed by a visitor terminal.

### DETAILED DESCRIPTION

Embodiments provide a commodity purchase system, a relay server, and a registration device with which a requester who is not present in a store can select and purchase commodities as if he or she is doing shopping in the store.

A commodity purchase system for assisting a customer who is not at a store in making purchase according to an embodiment includes a first terminal configured to capture an image of one or more commodities displayed in the store, a relay server configured to acquire commodity information about one of the commodities of the image, and a second terminal configured to display the commodity information and issue a purchase request for purchase of said one of the commodities for the customer, and issue a settlement request for settling purchase of one or more commodities purchased by the customer. The relay server is further configured to, upon issuance of the settlement request, cause the first terminal to output a screen through which a delivery method of the purchased commodities can be selected, calculate a payment amount of the purchased commodities and a reward for a user of the first terminal based on a selection result of the delivery method, and perform settlement processing on the purchased commodities based on the calculated payment amount and output reward information indicating the calculated reward.

A commodity purchase system according to one or more embodiments is explained below with reference to the drawings.

The commodity purchase system is a system with which an aged person or a person living in a remote place from a store requests another person, such as an acquaintance and a family member, to visit the store to purchase a commodity on his or her behalf. In the following explanation, the aged person or the person living in the remote place from the store is referred to as a requester and a person who visits the store and purchases a commodity for the requester is referred to as a visitor.

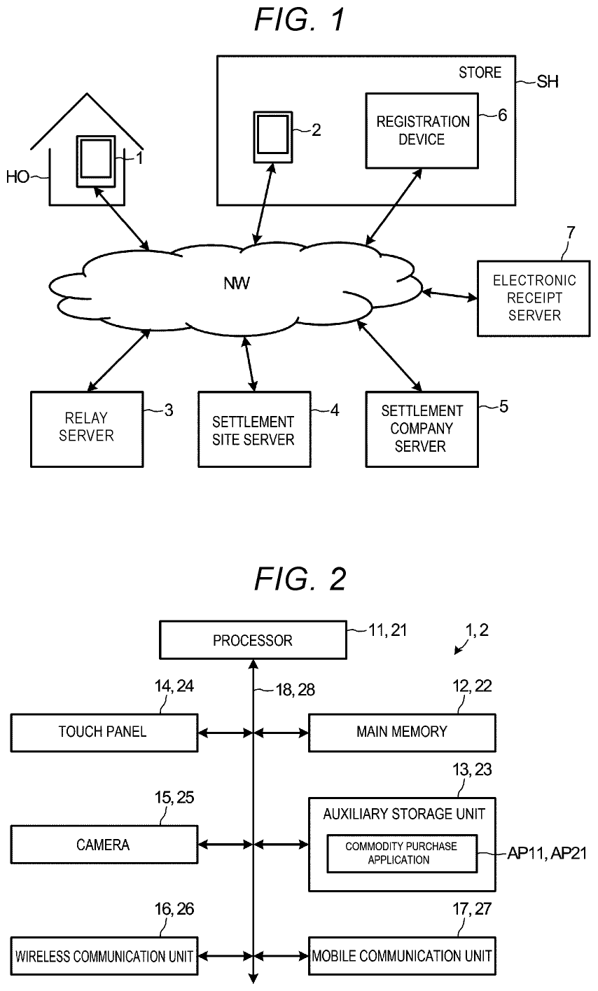

FIG. 1 is a schematic block diagram of the commodity purchase system according to an embodiment. The commodity purchase system includes a requester terminal 1, a visitor terminal 2, and a relay server 3. The requester terminal 1 and the visitor terminal 2 are capable of transmitting and receiving data via a communication network NW and capable of transmitting and receiving specific data relating to the commodity purchase system via the relay server 3 connected to the communication network NW.

The requester terminal 1 is a mobile terminal such as a smartphone or a personal computer operated by a requester who is at home HO distant from a store SH or a dedicated terminal configured to perform transmission and reception of data relating to the commodity purchase system. In the following explanation, it is assumed that the requester terminal 1 is a smartphone in which a commodity purchase application program for the commodity purchase system has been installed. An “application program” is hereinafter abbreviated as “application”.

The visitor terminal 2 is a portable terminal such as a smartphone or a tablet personal computer operated by a visitor visiting the store SH or a dedicated portable terminal such as a tablet terminal configured to perform transmission and reception of data relating to the commodity purchase system lent to the visitor in the store SH. In the following explanation, it is assumed that, like the requester terminal 1, the visitor terminal 2 is a smartphone in which the commodity purchase application for the commodity purchase system has been installed.

The relay server 3 relays data between the requester terminal 1 and the visitor terminal 2 in which the commodity purchase application stores data of a commodity that the requester requests the visitor to purchase. According to a settlement instruction transmitted from the requester terminal 1, the relay server 3 calculates a payment amount of the purchased commodity of the requester and transmits the calculated payment amount to a settlement site server 4 via the communication network NW to perform settlement processing.

The settlement site server 4 is capable of transmitting and receiving data to and from a settlement company server 5 via the communication network NW. The settlement company server 5 is a server operated by a settlement company such as a credit card company. The settlement site server 4 performs settlement in communication with the settlement company server 5 according to a settlement method designated by the requester. The settlement method includes an electronic commerce (FC) method such as credit card settlement, electronic money settlement, point settlement, or code settlement (also called mobile settlement, smartphone settlement, or the like). The code settlement can be used by, for example, linking a code and a credit card or electronic money in advance in the commodity purchase application installed in the requester terminal 1. A settlement agency server may be interposed between the settlement site server 4 and the settlement company server 5. Alternatively, the settlement site server 4 and the settlement company server 5 are integrated into a single server.

The commodity purchase system can further include a registration device 6 installed in the store SH. The registration device 6 is a device with which the visitor performs registration processing and settlement processing for a purchased commodity by himself or herself.

Once the payment amount of the commodity purchased by the requester according to the settlement instruction transmitted from the requester terminal 1, the relay server 3 inquires the visitor terminal 2 about whether the purchased commodity is delivered by the visitor or the store SH. This is because, since a delivery charge is incurred if the store SH delivers the purchased commodity, it is necessary to add the delivery charge to the payment amount. The relay server 3 determines the total payment amount according to a selection result of the delivery method by the visitor transmitted from the visitor terminal 2.

On the other hand, if the selection result of the delivery method by the visitor transmitted from the visitor terminal 2 is delivery by the visitor, the relay server 3 generates reward information indicating a reward granted to the visitor for his or her delivery. The reward can be application of a coupon, that is, a discount, granting of a point, and the like. In the following explanation, it is assumed that the reward is the application of the coupon.

After the settlement by the settlement site server 4 ends, the relay server 3 outputs settlement information including amount information to the visitor terminal 2 and the registration device 6. The amount information is a settlement completion list including a list of commodities purchased by the requester and the payment amounts. If award information such as coupon information involved in delivery by the visitor is generated, the relay server 3 includes the reward information in the settlement information. Therefore, if the visitor performs settlement processing for a commodity purchased by the visitor by himself or herself, the registration device 6 can apply a coupon based on the reward information to the transaction.

The registration device 6 dispenses a receipt concerning the commodity purchased by the requester and dispenses a receipt concerning the commodity purchased by the visitor, if any. The dispensing of the receipt may be printing on receipt paper by a printer or may be transmission of electronic receipt information to an electronic receipt server 7 via the communication network NW.

In FIG. 1, only one home HO, one requester terminal 1, one store SH, one visitor terminal 2, one settlement company server 5, one registration device 6, and one electronic receipt server 7 are illustrated. However, two or more requester terminals 1 operated by requesters being at their homes HO, two or more visitor terminals 2 visiting stores SH for the requesters, two or more settlement company servers 5, two or more registration devices 6, and/or two or more electronic receipt servers 7 may be present.

FIG. 2 is a hardware block diagram of the requester terminal 1 and the visitor terminal 2.

The requester terminal 1 includes a processor 11, a main memory 12, an auxiliary storage unit 13, a touch panel 14, a camera 15, a wireless communication unit 16, a mobile communication unit 17, and a system transmission line 18. The processor 11, the main memory 12, the auxiliary storage unit 13, the touch panel 14, the camera 15, and the mobile communication unit 17 are connected via the system transmission line 18. The processor 11, the main memory 12, and the auxiliary storage unit 13 connected by the system transmission line 18 make up a controller for controlling the requester terminal 1.

Similarly, the visitor terminal 2 includes a processor 21, a main memory 22, an auxiliary storage unit 23, a touch panel 24, a camera 25, a wireless communication unit 26, a mobile communication unit 27, and a system transmission line 28.

Each of the processor 11 and 21 executes an operating system and one or more information processing programs or applications to perform various functions of the requester terminal 1 or the visitor terminal 2. Each of the processors 11 and 21 is, for example, a CPU (central processing unit).

Each of the main memories 12 and 22 includes a nonvolatile memory region and a volatile memory region. Each of the main memories 12 and 22 stores the information processing programs in the nonvolatile memory region. Each of the main memories 12 and 22 may store, in the nonvolatile or volatile memory region, data necessary for the processor 11 or 21 to execute information processing. The volatile memory region of each of the main memories 12 and 22 is a work area in which data is temporarily stored by the processor 11 or 21. The nonvolatile memory region is, for example, a ROM (read only memory). The volatile memory region is, for example, a RAM (random access memory).

Each of the auxiliary storage units 13 and 23 is a storage device such as an EEPROM (electric erasable programmable read-only memory), an HDD (hard disc drive), and an SSD (solid state drive). Each of the auxiliary storage units 13 and 23 stores data used by the processor 11 or 21 in performing various kinds of processing or data generated by the processor 11 or 21. Each of the auxiliary storage units 13 and 23 may store the information processing programs.

Each of the touch panels 14 and 24 functions as an input device and a display device of the requester terminal 1 or the visitor terminal 2.

Each of the cameras 15 and 25 includes an optical system and an image sensor and generates, with the image sensor, image data representing a visual field formed by the optical system.

Each of the wireless communication units 16 and 26 exchanges data with an access point installed in the home HO or the store SH by wireless communication conforming to a wireless communication protocol. As the wireless communication unit 16 or 26, for example, a well-known communication device conforming to the IEEE802.11 standard can be used. The access point of the store SH is connected to a store LAN (local area network). The store LAN is connected to the communication network NW via a gateway.

The of the mobile communication units 17 and 27 is a network interface circuit for data communication via the communication network NW. As the mobile communication unit 17 or 27, for example, a well-known communication device for performing data communication via a mobile communication network can be used.

Each of the system transmission lines 18 and 28 includes an address bus, a data bus, and a control signal line through which data and control signals are exchanged among the connected components.

The auxiliary storage units 13 and 23 store commodity purchase applications AP11 and AP21, respectively. The commodity purchase application AP11 and the commodity purchase application AP21 are the same program for respectively causing the requester terminal 1 and the visitor terminal 2 to function as a user interface of the commodity purchase system. The commodity purchase applications AP11 and AP21 are used in common in a plurality of requester terminals 1 or a plurality of visitor terminals 2.

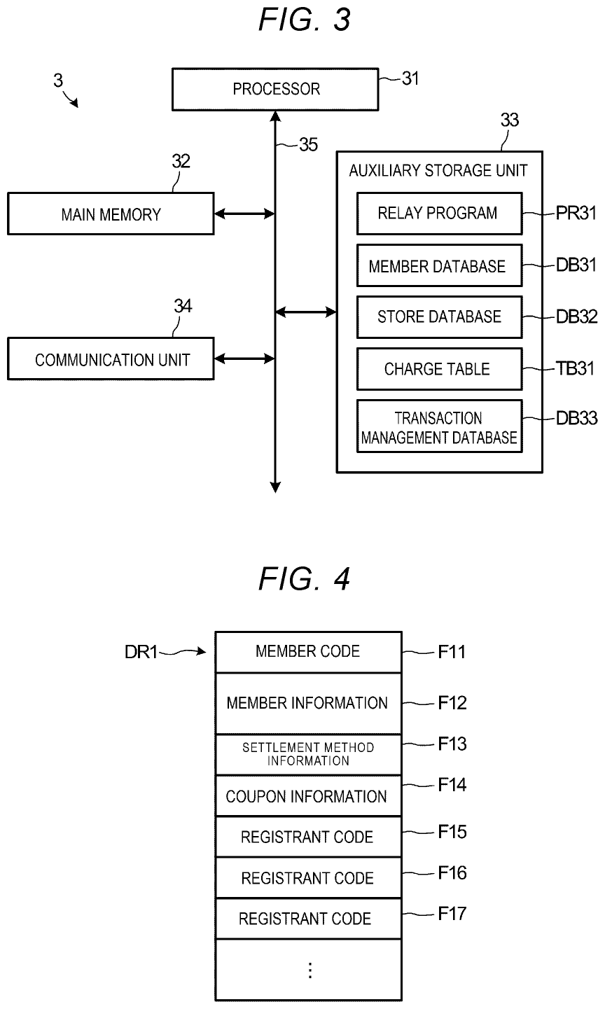

FIG. 3 is a hardware block diagram of the relay server 3. The relay server 3 includes a processor 31, a main memory 32, an auxiliary storage unit 33, a communication unit 34, and a system transmission line 35. The processor 31, the main memory 32, the auxiliary storage unit 33, and the communication unit 34 are communicably connected via the system transmission line 35. The processor 31, the main memory 32, and the auxiliary storage unit 33 connected by the system transmission line 35 make up a controller for controlling the relay server 3. The functions of the processor 31, the main memory 32, the auxiliary storage unit 33, and the system transmission line 35 are similar to the functions of the processor 11, the main memory 12, the auxiliary storage unit 13, and the system transmission line 18.

The communication unit 34 is a network interface circuit configured to perform data communication via the communication network NW. The communication unit 34 is, for example, a network interface card (NIC).

The auxiliary storage unit 33 stores a relay program PR31, which is one of the information processing programs used in the commodity purchase system. The relay program PR31 is executed by the processor 31 to perform the functions of the relay server 3.

The auxiliary storage unit 33 stores a member database DB31, a store database DB32, a charge table TB31, and a transaction management database DB33.

FIG. 4 depicts a data structure of a data record DR1 included in the member database DB31. The member database DB31 is a database for managing information about a requester who has been registered to the commodity purchase system as a member. Accordingly, the member database DB31 includes data records DR1 as many as registered users. The data record DR1 includes fields F11, F12, F13, F14, and F15. The data record DR1 can further include additional fields including F16, F17, . . . .

In the field F11, a member code for distinguishing the correlated requester from other requesters is set. The member code is, for example, a unique identification code set for each user in order to identify individual users of the commodity purchase system. Alternatively, as the member code, for example, an identification code set for the commodity purchase application AP11 or AP21 can be used if such an application AP11 or AP22 is installed in the requester terminal 1 or the visitor terminal 2.

In the field F12, member information, which is attribute information about the requester specified by the member code, is set. The member information includes a name, sex, age, an address, a telephone number, and an electronic mail address. The member information is used if a commodity purchased by the requester is delivered from the store SH.

In the field F13, settlement method information about a settlement method designated by the requester is set. The settlement method information is a credit card number, a code settlement ID (identifier), or the like. If a plurality of settlement methods is selectable, the settlement method information includes a settlement method code for identifying a settlement method.

In the field F14, coupon information indicating a coupon that has been granted to the requester by the store SH is set. The coupon information may include an ID of a point service and the amount of granted points.

In the field F15, a registrant code for identifying a registrant registered as a visitor by the requester is set. As the registrant code, like the member code, a unique identification code set for each user of the commodity purchase system. An identification code set for the commodity purchase application AP11 or AP21 can also be used. That is, one identification code is used as a member code if the member uses the commodity purchase system as a requester and is used as a registrant code if the member uses the commodity purchase system as a visitor. The registrant code is saved as a history unless deletion operation is performed by the user. Accordingly, every time a requester requests a new visitor to purchase a commodity, a new registrant code is added in the field F16, F17, . . . in the data record DR1.

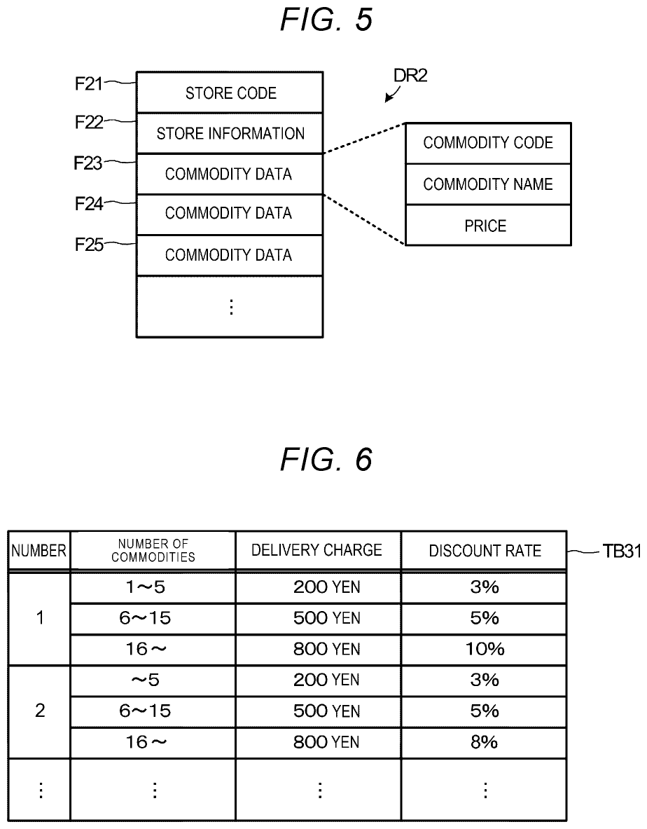

FIG. 5 is a schematic diagram illustrating a data structure of a data record DR2 included in the store database DB32. The store database DB32 is a database for managing information about the store SH using the commodity purchase system and is a set of data records correlated with the registered store SH. Accordingly, the store database DB32 includes data records DR2 as many as registered stores SH. The data record DR2 includes fields F21, F22, F23, F24, F25, F26 . . . .

In the field F21, a store code for distinguishing the correlated store SH from other stores SH is set. The store code is, for example, a unique identification code set for each store SH in order to identify individual stores SH of the commodity purchase system.

In the field F22, store information, which is attribute information about the store SH specified by the store code, is set. The store information includes a store name, an address, and a telephone number. The store information can further include information indicating whether the store SH is a store that adopts a fixed coupon, a discount amount of which does not vary depending on conditions, or a store that adopts a variable coupon, a discount amount of which varies depending on conditions.

In the field F23, if the correlated store SH adopts the variable coupon, a table number in the charge table TB31 used by the store SH is set. The table number is explained below together with details of the charge table TB31. If the correlated store SH adopts the fixed coupon, information concerning the fixed coupon may be set in the field F23.

In the fields F24, F25, F26, . . . , commodity data correlated with commodities sold by the correlated store SH are set. The commodity data indicate commodity information about the correlated commodities such as commodity codes, commodity names, and prices. The commodity code is an identification code to identify a commodity for each SKU (stock keeping unit). For example, a JAN (Japanese article number) code is used. The commodity name is a name of the commodity. The price is a sales price of the commodity.

FIG. 6 depicts a data structure of the charge table TB31. In the charge table TB31, for example, in association with the number of commodities that have been purchased by the requester, a delivery charge for delivering the commodities from the store SH to the requester's home and a discount rate applicable to the visitor's purchase as a reward if the visitor delivers the commodities purchased by the requester to the requester's home. Since the number of purchased commodities, the delivery charge, and the discount rate can be set for each store SH, in the charging table TB31, pluralities of numbers of purchased commodities, delivery charges, and discount rates are stored in association with charge table numbers. A relation among the number of purchased commodities, the delivery charge, and the discount rate can be set in the data record DR2 of the store SH in the store database DB32. However, the same setting may be used in a plurality of stores SH. Therefore, the numbers of purchased commodities, the delivery charges, and the discount rates are collectively managed in one charge table TB31. In the data record DR2 in the store database DB32, the charge table numbers of the charge table TB31 are set in the field F23.

Although the delivery charge and the discount rate are set in association with the number of purchased commodities, it goes without saying that other conditions may be adopted or further taken into account. For example, a delivery cost based on a distance from the address of the requester acquirable from the member database DB31 to the address of the store acquirable from the store database DB32 may be used as a setting condition for the delivery charge and the discount rate. It is also conceivable to, by including weight data and sizes in commodity data set in the store database DB32, calculate a total weight and a total size of commodities purchased by the requester and use the total weight and the total size as setting conditions for the delivery charge and the discount rate. The reward may be not limited to application of a discount rate. Any other rewards such as application of a fixed discount amount may be used.

FIG. 7 depicts a data structure of a data record DR3 included in the transaction management database DB33. The transaction management database DB33 is a database for managing transactions in the commodity purchase system and is a set of data records correlated with the transactions. Accordingly, the transaction management database DB33 includes data records DR3 as many as the transactions. The data record DR3 includes fields F31, F32, F33, F34, F35, F36, F37, F38, . . . .

In the field F31, a transaction number for distinguishing the correlated transaction from other transactions is set. The transaction number is, for example, a unique identification code set for each transaction in order to identify individual transactions in the commodity purchase system.

In the fields F32, F33, and F34, a member code, a registrant code, and a store code for specifying a requester, a visitor, and the store SH relating to the transaction are set.

In the field F35, a date and time of completion of a transaction end is set as date information.

In the fields F36, F37, F38, . . . , registration data correlated with a purchased commodity of the requester are set. The registration data includes data concerning the correlated purchased commodity such as a commodity code, a commodity name, a quantity, a unit price, and a total amount.

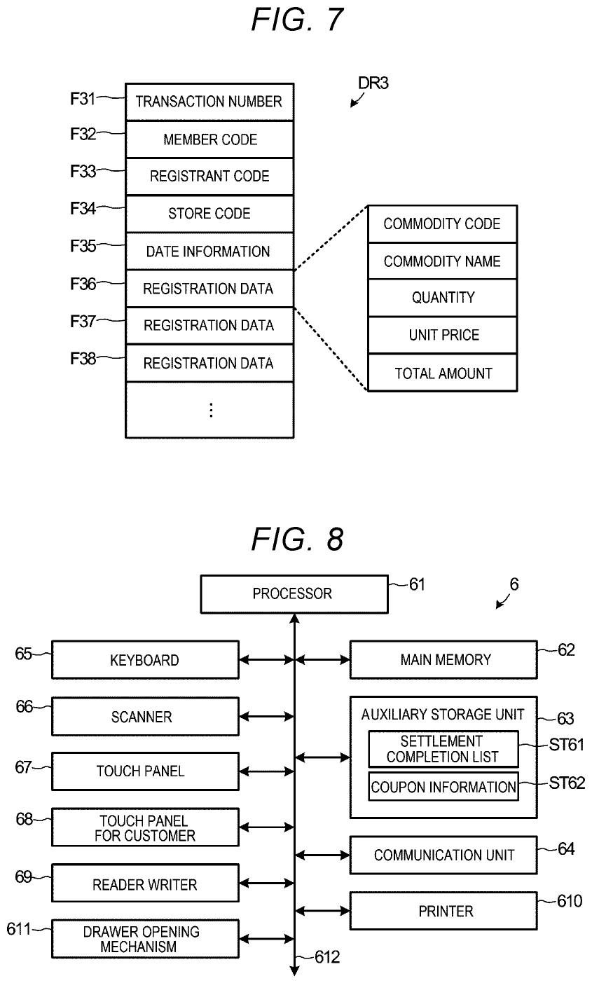

FIG. 8 is a hardware block diagram of the registration device 6. The registration device 6 is a POS (Point Of Sales) terminal and includes a processor 61, a main memory 62, an auxiliary storage unit 63, a communication unit 64, a keyboard 65, a scanner 66, a touch panel 67, a touch panel for customer 68, a reader writer 69, a printer 610, a drawer opening mechanism 611, and a system transmission line 612. The processor 61, the main memory 62, the auxiliary storage unit 63, the communication unit 64, the keyboard 65, the scanner 66, the touch panel 67, the touch panel for customer 68, the reader writer 69, the printer 610, and the drawer opening mechanism 611 are connected to one another via the system transmission line 612. The processor 61, the main memory 62, and the auxiliary storage unit 63 connected by the system transmission line 612 make up a controller of the registration device 6. Functions of the processor 61, the main memory 62, the auxiliary storage unit 63, and the system transmission line 612 are similar to the functions of the processor 11, the main memory 12, the auxiliary storage unit 13, and the system transmission line 18.

The communication unit 64 is a network interface circuit for data communication via the store LAN. The communication unit 64 receives settlement information from the relay server 3 via the store LAN and the communication network NW. The auxiliary storage unit 63 includes a settlement-completion-list storing section ST61 and a coupon-information storing section ST62. In the settlement-completion-list storing section ST61, a settlement completion list included in the settlement information received from the relay server 3 is stored. In the coupon-information storing section ST62, coupon information included in the settlement information received from the relay server 3 is stored. The communication unit 64 can also perform data communication with other registration devices 6 and store servers in the store SH connected via the store LAN.

The keyboard 65 has a plurality of keys including numeric keys, a subtotal key, a cancel key, and a clear key. The functions of the subtotal key, the cancel key, the clear key, and the like may be allocated to other general-purpose keys such as numeric keys.

The scanner 66 reads a code symbol such as a barcode or a two-dimensional data code. The scanner 66 may be a type for reading the code symbol by scanning a laser beam or may be a type for reading the code symbol by capturing an image with an imaging device.

The touch panel 67 is a device functioning as both of an input device and a display device. The touch panel 67 displays information to a store clerk, who is an operator of the registration device 6, and receives an operation input by the store clerk.

The keyboard 65, the scanner 66, and the touch panel 67 make up an input and output device for the store clerk to perform registration operation for a purchased commodity.

Like the touch panel 67, the touch panel for customer 68 is a device functioning as both of an input device and a display device. The touch panel for customer 68 displays information to a visitor, who is a shopper for whom registration of a commodity to be purchased is performed in the registration device 6, and receives an operation input by the visitor.

The reader writer 69 has a function of reading data recorded in a medium such as a card or a smartphone and a function of writing data in the medium. For example, the card is a membership card or a point card besides a payment card for settlement such as a credit card, a debit card, an electronic money card, and a prepaid card. The reader writer 69 may be a device of any one of a magnetic type, a contact type, and a noncontact type or may include a plurality of types of devices.

The printer 610 dispenses a receipt by printing various character strings, images, or the like on receipt paper. As the printer 610 of this type, for example, a thermal printer or a dot impact printer can be used.

The drawer opening mechanism 611 opens a drawer for storing cash or notes such as gift certificates and coupons.

The operation of the commodity purchase system is explained. Various kinds of processing explained below are mere examples. Modification to a part of the processing, omission of a part of the processing, addition of other processing, and the like are possible as appropriate. For example, in the following explanation, some parts of the processing are omitted in order to clearly explain characteristic operation in a particular embodiment. For example, if an error occurs, processing for coping with the error may be performed. However, description about such processing is omitted.

A service provided to a user through the operation of the commodity purchase system explained below is referred to as a commodity purchase service.

In order to use the commodity purchase service, the user installs the commodity purchase application AP11 or AP21 in, for example, his or her smartphone to use the smartphone as the requester terminal 1 or the visitor terminal 2. The user as the requester designates, using a smartphone function such as a telephone, an email, or a chat or orally, the store SH, which is affiliated with the commodity purchase service, and requests another user to purchase a commodity in the store SH as a visitor. The requester and the visitor communicate with each other by the telephone, the email, or the chat and start the commodity purchase applications AP11 and AP21 each other at any timing such as the visitor's entry to the designated store SH. The commodity purchase applications AP11 and AP22 may have the functions of telephone, email, chat, or the like so that the requester and the visitor may communicate with each other during the purchase.

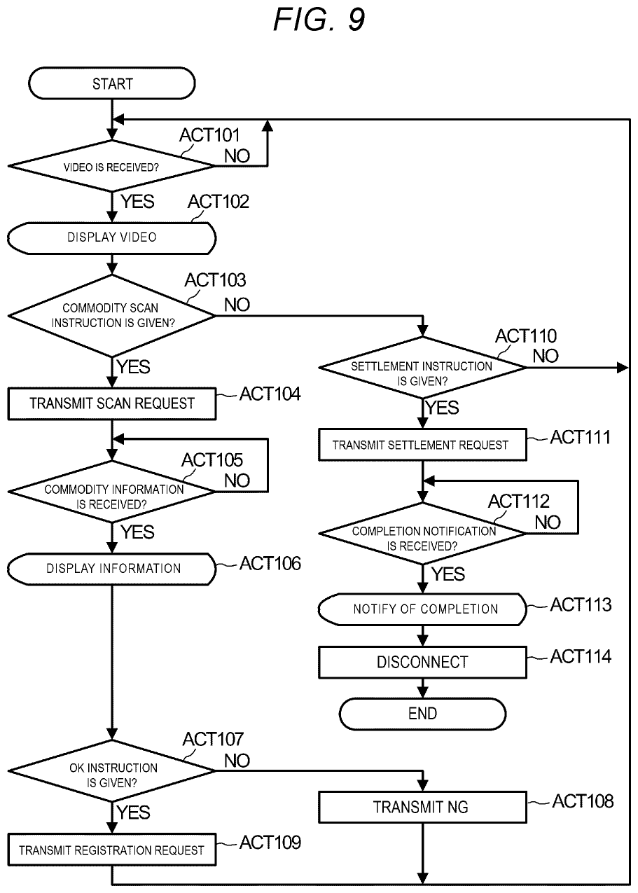

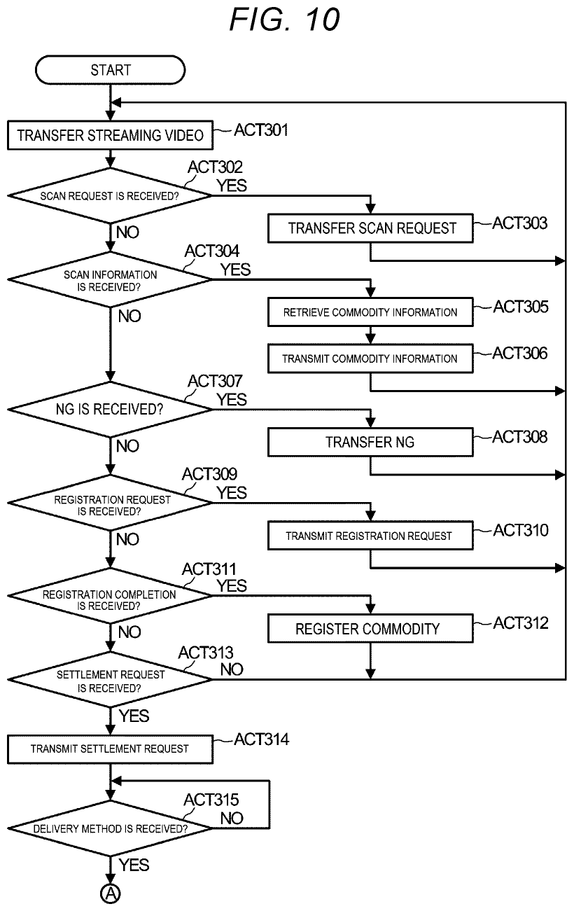

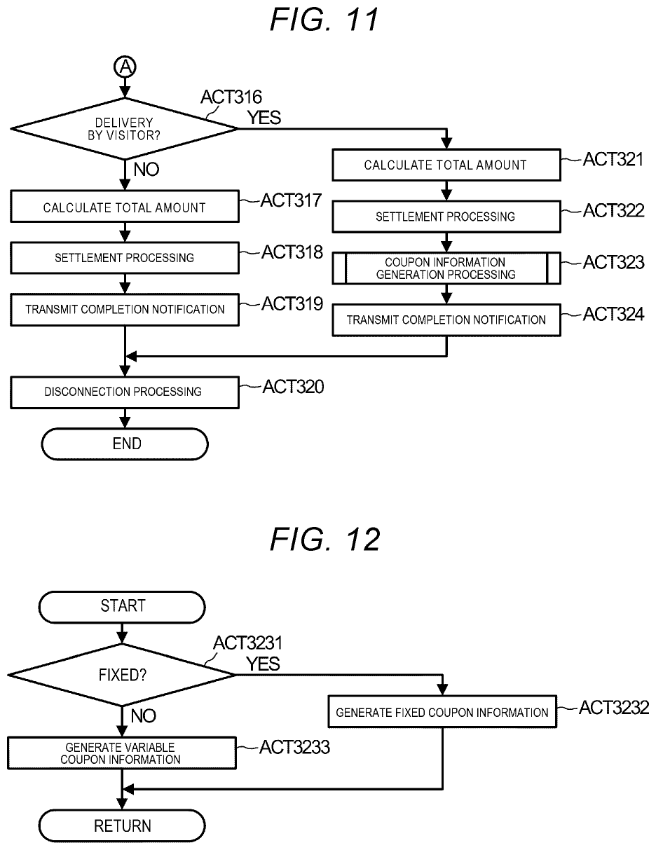

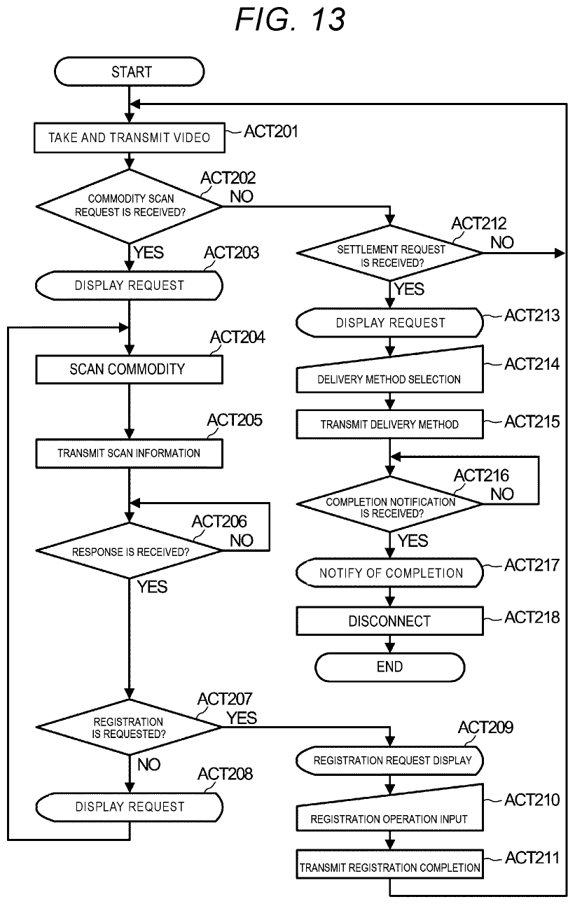

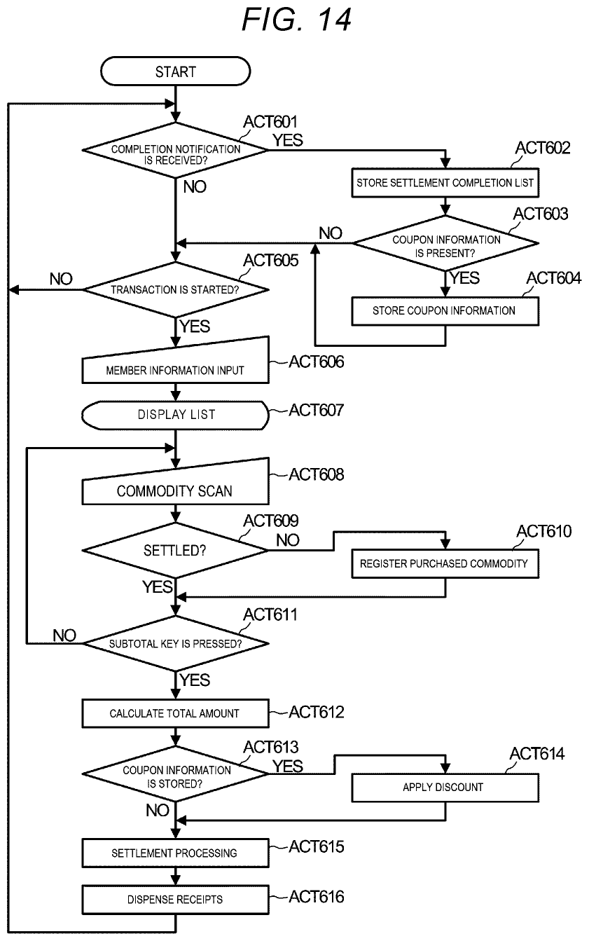

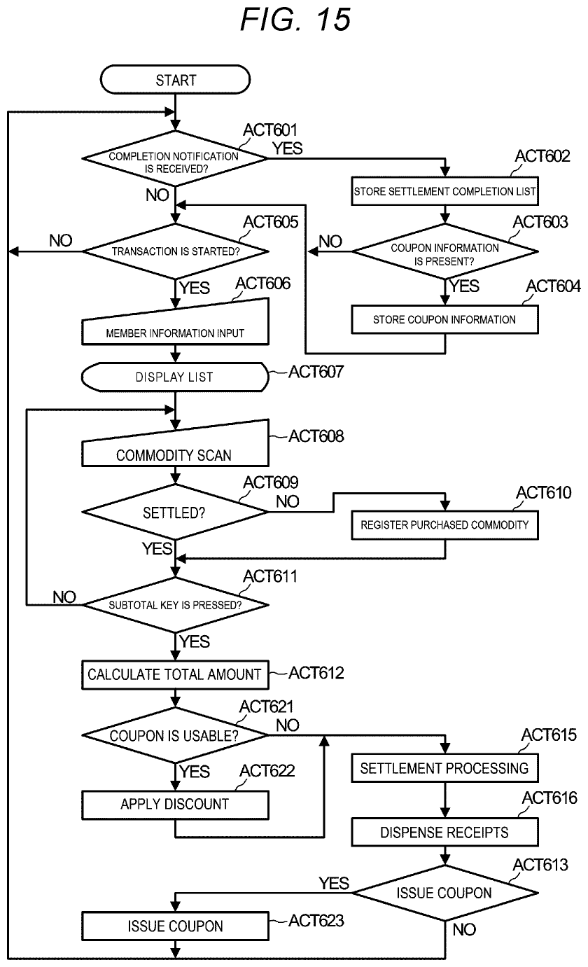

FIG. 9 is a flowchart of information processing based on the commodity purchase application AP11 executed by the processor 11 of the requester terminal 1. FIGS. 10 and 11 are flowcharts of information processing based on the relay program PR31 executed by the processor 31 of the relay server 3. FIG. 12 is a flowchart of coupon information generation processing. FIG. 13 is a flowchart of information processing based on the commodity purchase application AP21 executed by the processor 21 of the visitor terminal 2. FIGS. 14 and 15 are flowcharts of information processing executed by the processor 61 of the registration device 6.

It is assumed that the commodity purchase applications AP11 and AP21 are started by the processors 11 and 21 of the requester terminal 1 and the visitor terminal 2 and connected to the relay server 3, and necessary processing such as authentication have already been carried out. Although not particularly illustrated, according to this processing, the processor 31 of the relay server 3 generates, in the transaction management database DB33, the data record DR3 having a new transaction number and sets, in the data record DR1 corresponding to the requester and the visitor in the member database DB31, information for data transmission such as an identification code and an IP address of each of the commodity purchase applications AP11 and AP21.

In ACT 101 in FIG. 9, the processor 11 of the requester terminal 1 waits for a streaming video transmitted from the visitor terminal 2 through the relay server 3 to be received by the wireless communication unit 16.

The visitor moves towards a commodity shelf on which a commodity, which is notified beforehand from the requester, is displayed in the store SH and uses the camera 25 of the visitor terminal 2 to take one or more images or videos of the commodity shelf. During the movement, the visitor may put a commodity to be purchased by the visitor in a shopping basket, that is, simultaneously carry out shopping for the visitor himself or herself. In ACT 201 in FIG. 13, the processor 21 of the visitor terminal 2 controls the wireless communication unit 26 to transmit a video taken by the camera 25 to the relay server 3 as a streaming video.

In ACT 301 in FIG. 10, upon receipt of the streaming video from the visitor terminal 2 via the communication unit 34, the processor 31 of the relay server 3 controls the communication unit 34 to transfer the streaming video to the requester terminal 1.

In ACT 101, upon receipt of the streaming video from the visitor terminal through the wireless communication unit 16, the processor 11 of the requester terminal 1 controls the touch panel 14 to display the streaming video in ACT 102.

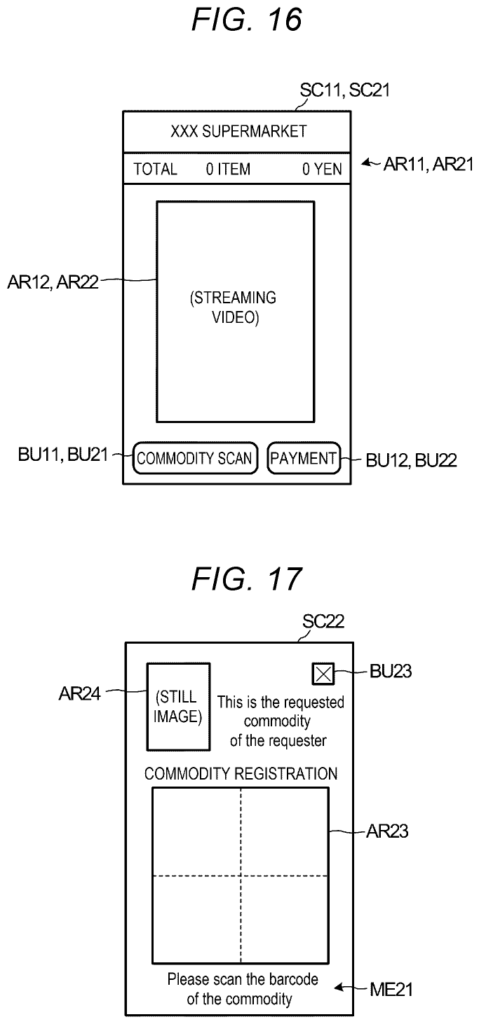

FIG. 16 depicts an example of a streaming screen SC11 displayed on the touch panel 14 of the requester terminal 1. The streaming screen SC11 includes display areas AR11 and AR12 and buttons BU11 and BU12. The display area AR11 displays a total number of items of commodities to be purchased and a total amount of prices of the commodities. The display area AR12 displays a streaming video. The button BU11 is a soft key for the requester to request the visitor to scan a commodity. The button BU12 is a soft key for the requester to settle the commodities.

Thereafter, in ACT 103, the processor 11 of the requester terminal 1 determines whether an instruction for commodity scan is given. If a commodity desired to be purchased is shown in the streaming video displayed in the display area AR12, the requester touches the commodity shown in the video. Accordingly, the processor 11 determines presence or absence of the instruction for commodity scan according to presence or absence of the touch operation on the display area AR12 by the requester.

If the instruction for commodity scan is given, in ACT 104, the processor 11 of the requester terminal 1 controls the wireless communication unit 16 to transmit a commodity scan request to the relay server 3. The commodity scan request includes coordinate information indicating coordinates of the touched display area AR12. The commodity scan request may further include a frame number of the streaming video when the requester touches the display area AR12. Thereafter, in ACT 105, the processor 11 of the requester terminal 1 waits for commodity information transmitted from the relay server 3 to be received by the wireless communication unit 16.

After transferring the streaming video received from the visitor terminal 2 to the requester terminal 1 in ACT 301, in ACT 302, the processor 31 of the relay server 3 determines whether the commodity scan request transmitted from the requester terminal 1 is received by the communication unit 34. If determining that the scan request transmitted from the requester terminal 1 is received, in ACT 303, the processor 31 controls the communication unit 34 to transfer the scan request to the visitor terminal 2. Thereafter, the processor 31 proceeds to ACT 301.

After transmitting the streaming video to the relay server 3 in ACT 201, in ACT 202, the processor 21 of the visitor terminal 2 determines whether the commodity scan request transmitted from the requester terminal 1 through the relay server 3 is received by the wireless communication unit 26. If determining that the commodity scan request is received, in ACT 203, the processor 21 controls the touch panel 24 to display information indicating that the commodity scan request is received. At this time, in order to surely notify the visitor that the commodity scan request is received, the processor 21 may control a speaker to output an alarm sound or a vibration mechanism such as a motor to vibrate.

In the visitor terminal 2, while the streaming video is transmitted, the screen same as the streaming screen SC11 in the requester terminal 1 is displayed on the touch panel 24. That is, as illustrated in FIG. 16, a streaming screen SC21 includes display areas AR21 and AR22 and buttons BU21 and BU22. The display areas AR21 and AR22 and the button BU21 are the same as the display areas AR11 and AR12 and the button BU11 of the streaming screen SC11 in the requester terminal 1. The button BU22 does not have a function of a soft key unlike the button BU12 of the streaming screen SC21 and is only displayed as a button image. In such a streaming screen SC21, the processor 21 performs, for example, display of the commodity scan request explained below. That is, the processor 21 controls the touch panel 24 to output a visual notification such as flashing of the button BU21. Further, the processor 21 switches the video displayed in the display area AR22 from the streaming video to a still image. At this time, if a frame number is included in the received commodity scan request, the processor 21 can display the frame image specified by the frame number. If any frame number is not included in the commodity scan request, the processor 21 selects a frame image based on the time when the commodity scan request is transmitted. The processor 21 controls the touch panel 24 to display, based on the coordinates included in the commodity scan request, on the still image, a touch position mark indicating a position of the image touched by the requester. The visual notification may be made by flashing or changing colors of a frame line of the display area AR22.

The visitor checks the still image and the touch position mark in the display of the commodity scan request and specifies a commodity presumed to be designated by the requester. The visitor touches the button BU22 on the streaming screen SC21 to declare that the visitor will perform scan of the commodity. Consequently, in ACT 204, the processor 21 switches the streaming screen SC21 to a registration screen and performs the scan of the commodity.

FIG. 17 depicts an example of a registration screen SC22 in the visitor terminal 2. The registration screen SC22 is a screen for reading a barcode representing a commodity code of a commodity to be registered. The registration screen SC22 includes display areas AR23 and AR24, a message ME21, and a button BU23. The display area AR23 displays an image obtained by the camera 25. The display area AR23 displays the still image displayed in the display area AR22 of the streaming screen SC21. The message ME21 is a message for instructing the visitor to scan a barcode of the commodity. The button BU23 is a soft key for stopping the scan of the commodity code.

The visitor photographs a barcode or a two-dimensional barcode on a box and a label of the commodity presumed to be designated by the specified requester or a commodity explanation tag provided in a commodity shelf on which the commodity is displayed. The processor 21 decodes the scanned commodity code, that is, reads the commodity code from the photographed image of the barcode or the two-dimensional barcode. In ACT 205, the processor 21 controls the wireless communication unit 26 to transmit scan information including the read commodity code to the relay server 3. Thereafter, in ACT 206, the processor 21 waits for a response from the relay server 3 to be received.

If determining in ACT 302 that the commodity scan request is not received from the requester terminal 1, in ACT 304, the processor 31 of the relay server 3 determines whether the scan information transmitted from the visitor terminal 2 is received by the communication unit 34. If determining that the scan information is received from the visitor terminal 2, in ACT 305, the processor 31 retrieves, from the data record DR2 of the store in the store database DB32, commodity information corresponding to the commodity code included in the scan information. In ACT 306, the processor 31 controls the communication unit 34 to transmit the retrieved commodity information to the requester terminal 1. Thereafter, the processor 31 proceeds to ACT 301.

If determining in ACT 105 that the commodity information transmitted from the relay server 3 is received, in ACT 106, the processor 11 of the requester terminal 1 switches the display of the touch panel 14 from the streaming screen SC11 to a commodity information display screen and causes the touch panel 14 to display the received commodity information. Although not particularly illustrated, the commodity information display screen includes an OK button and an NG button for selecting whether to purchase the commodity indicated by the commodity information.

The requester touches the OK button if the displayed commodity information indicates the commodity intended to be purchased. Otherwise, the requester touches the NG button. Accordingly, in ACT 107, the processor 11 determines whether an OK instruction is given through the OK button. If the OK instruction is not given, that is, an NG instruction is given through the NG button, in ACT 108, the processor 11 controls the wireless communication unit to transmit NG information to the relay server 3. Thereafter, the processor 11 proceeds to ACT 101.

If determining in ACT 304 that the scan information is not received from the visitor terminal 2, in ACT 307, the processor 31 of the relay server 3 determines whether the NG information transmitted from the requester terminal 1 is received by the communication unit 34. If determining that the NG information is received from the requester terminal 1, in ACT 308, the processor 31 controls the communication unit 34 to transmit the NG information to the visitor terminal 2. Thereafter, the processor 31 proceeds to ACT 301.

If determining in ACT 206 that a response from the relay server 3 is received, in ACT 207, the processor 21 of the visitor terminal 2 determines whether the response is a registration request. If determining that the response is not the registration request, that is, the response indicates the NG information, in ACT 208, the processor 21 causes the touch panel 24 to display a re-scan request.

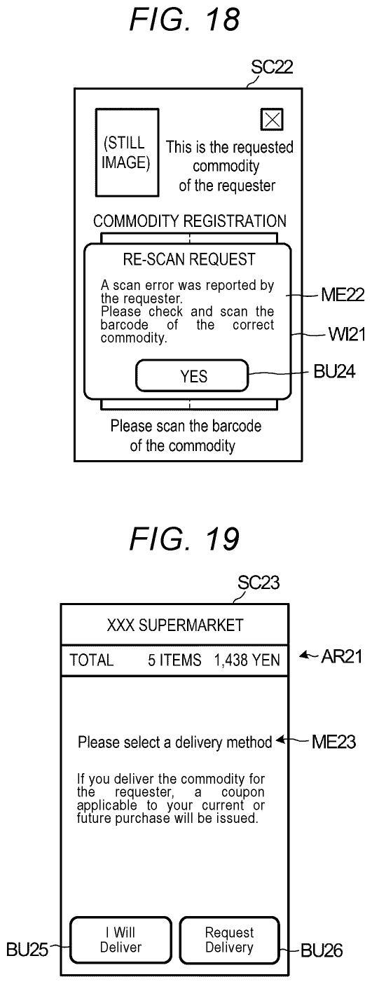

FIG. 18 depicts an example of a re-scan request displayed by the visitor terminal 2. The processor 21 controls the touch panel 24 to display a display window WI21 in the registration screen SC22. The display window WI21 includes a message ME22 and a button BU24. The message ME22 is a message indicating that another commodity needs to be scanned. The button BU24 is a key for confirmation on the re-scan request.

The processor 21 proceeds to ACT 204 according to the touch operation on the button BU24 by the visitor. The visitor scans another commodity.

On the other hand, if the commodity information displayed on the requester terminal 1 indicates the commodity that the requester intends to purchase, the requester touches the OK button. In such a case, the processor 11 determines in ACT 107 that the OK instruction by the touch operation on the OK button is given. In ACT 109, the processor 11 controls the wireless communication unit 16 to transmit a registration request to the relay server 3. Thereafter, the processor 11 proceeds to ACT 101.

If determining in ACT 307 that the NG information is not received from the requester terminal 1, in ACT 309, the processor 31 of the relay server 3 determines whether the registration request transmitted from the requester terminal 1 is received by the communication unit 34. If determining that the registration request transmitted from the requester terminal 1 is received, in ACT 310, the processor 31 controls the communication unit 34 to transmit the registration request to the visitor terminal 2. Thereafter, the processor 31 proceeds to ACT 301.

If determining in ACT 207 that the registration request is received, in ACT 209, the processor 21 of the visitor terminal 2 causes the touch panel 24 to display a screen indicating the registration request. In the registration request, although not particularly illustrated, the message ME22 illustrated in FIG. 18 is only changed to a message indicating that a commodity is being purchased. The visitor who has confirmed the registration request display puts the commodity in a shopping basket as a commodity to be purchased by the requester. The visitor touches a button for declaring that the registration request is confirmed. In ACT 210, the processor 21 determines that the touch is a registration operation input for declaring registration of the commodity. Accordingly, in ACT 211, the processor 21 controls the wireless communication unit 26 to transmit registration completion to the relay server 3. Thereafter, the processor 21 proceeds to ACT 201.

If determining in ACT 309 that the registration request transmitted from the requester terminal 1 is not received, in ACT 311, the processor 31 of the relay server 3 determines whether the registration completion is received from the visitor terminal 2 by the communication unit 34. If determining that the registration completion is received from the visitor terminal 2, in ACT 312, the processor 31 registers the commodity. That is, the processor 31 generates registration data of the commodity and adds the registration data to the data record DR3 in the transaction management database DB33 corresponding to the requester. Thereafter, the processor 31 proceeds to ACT 301.

If determining in ACT 311 that the registration completion is not received from the visitor terminal 2, in ACT 313, the processor 31 of the relay server 3 determines whether a settlement request transmitted from the requester terminal 1 is received by the communication unit 34. If the transmission request is not received from the requester terminal 1, the processor 31 proceeds to ACT 301.

If determining in ACT 103 that the instruction for commodity scan is not given, in ACT 110, the processor 11 of the requester terminal 1 determines whether a settlement instruction by the touch operation on the button BU12 of the streaming screen SC21 is given. If the settlement instruction is not given, the processor 11 proceeds to ACT 101. In contrast, if determining that the settlement instruction is given, in ACT 111, the processor 11 controls the wireless communication unit 16 to transmit a settlement request to the relay server 3. Thereafter, in ACT 112, the processor 11 waits for a settlement completion notification transmitted from the relay server 3 to be received by the wireless communication unit 16.

If determining in ACT 313 that the transmission request is received from the requester terminal 1, in ACT 314, the processor 31 of the relay server 3 controls the communication unit 34 to transmit a settlement request to the visitor terminal 2. Thereafter, in ACT 315, the processor 31 waits for information about a delivery method to be received from the visitor terminal 2 by the communication unit 34.

If determining in ACT 202 that the commodity scan request is not received, in ACT 212, the processor 21 of the visitor terminal 2 determines whether the settlement request is received from the relay server 3 by the wireless communication unit 26. If the settlement request is not received, the processor 21 proceeds to ACT 201.

In contrast, if determining that settlement request is received, in ACT 213, the processor 21 controls the touch panel 24 to display a delivery method selection screen to notify of the settlement request.

FIG. 19 depicts a delivery method selection screen SC23 displayed by the visitor terminal 2. The delivery method selection screen SC23 includes the display area AR21, a message ME23, and buttons BU25 and BU26. The display area AR21 is as explained above. The message ME23 is a message for requesting the visitor to select whether the visitor delivers the commodity purchased by the requester or the visitor requests the store SH to deliver the purchased commodity. The message ME23 indicates that a reward such as a coupon will be issued for the visitor if the visitor delivers the purchased commodity. The button BU25 is a soft key for the visitor to declare that the visitor will deliver the purchased commodity to the requester. The button BU26 is a softkey for the visitor to declare that the visitor requests the store SH to deliver the purchased commodity.

Once a delivery method is selected in ACT 214, in ACT 215, the processor 21 controls the wireless communication unit 26 to transmit information about the selected delivery method to the relay server 3. Thereafter, in ACT 216, the processor 21 waits for a settlement completion notification transmitted from the relay server 3 to be received by the wireless communication unit 26.

If determining in ACT 315 that the information about the delivery method is received from the visitor terminal 2, in ACT 316, the processor 31 of the relay server 3 determines whether the delivery is made by the visitor.

If the delivery method is not made by the visitor, that is, a delivery is requested to the store SH, in ACT 317, the processor 31 calculates, based on the data record DR3 in the transaction management database DB33 corresponding to the requester, total amount information including the total amount of commodities purchased by the requester and the tax amount. In ACT 318, the processor 31 executes settlement processing. The settlement processing includes processing for transmitting, with the communication unit 34, the calculated total amount to the settlement site server 4 together with the settlement method information set in the field F13 of the data record DR1 in the member database DB31 corresponding to the requester. The settlement processing includes processing for receiving, with the communication unit 34, a settlement result from the settlement site server 4. After the settlement ends, in ACT 319, the processor 31 controls the communication unit 34 to transmit a settlement completion notification to the requester terminal 1, the visitor terminal 2, and the registration device 6 of the store SH. The settlement completion notification includes, for example, a settlement completion list indicating a list of transaction numbers and purchased commodities, which are indicated in the data record DR3 in the transaction management database DB33 relating to the current transaction. In ACT 320, the processor 31 disconnects the requester terminal 1 and the visitor terminal 2.

If determining in ACT 112 that the settlement completion notification transmitted from the relay server 3 is received, in ACT 113, the processor 11 of the requester terminal 1 controls the touch panel 14 to notify of settlement completion based on the received settlement completion notification. In ACT 114, the processor 11 controls the wireless communication unit 16 to disconnect from the relay server 3.

Similarly, if determining in ACT 216 that the settlement completion notification transmitted from the relay server 3 is received, in ACT 217, the processor 21 of the visitor terminal 2 controls the touch panel 24 to notify of settlement completion based on the received settlement completion notification. In ACT 218, the processor 21 controls the wireless communication unit 26 to disconnect from the relay server 3.

In ACT 601 in FIG. 14, the processor 61 of the registration device 6 of the store SH determines whether the settlement completion notification is received from the relay server 3 by the communication unit 64. If the settlement completion notification is received, in ACT 602, the processor 61 stores, in the settlement-completion-list storing section ST61, the settlement completion list included in the settlement completion notification.

On the other hand, if the delivery method designated by the visitor is delivery himself or herself, in ACT 321, the processor 31 calculates the total payment amount including the tax amount based on the content of the data record DR3 in the transaction management database DB33 corresponding to the requester and the delivery charge shown in the charge table TB31. In ACT 322, the processor 31 executes settlement processing. After the settlement ends, in ACT 323, the processor 31 executes coupon information generation processing for generating coupon information. Details of the coupon information generation processing are explained below. In ACT 324, the processor 31 controls the communication unit 34 to transmit a settlement completion notification to the requester terminal 1, the visitor terminal 2, and the registration device 6 of the store SH. The settlement completion notification can include the coupon information generated in ACT 323 in addition to the settlement completion list. Thereafter, the processor 31 proceeds to ACT 320.

After storing the settlement completion list in the settlement-completion-list storing section ST61 in ACT 602, in ACT 603, the processor 61 of the registration device 6 of the store SH determines whether coupon information is included in the settlement completion notification. If coupon information is included, in ACT 604, the processor 61 stores the coupon information included in the settlement completion notification in the coupon-information storing section ST62.

In the coupon information generation processing in ACT 323, in ACT 3231 in FIG. 12, the processor 31 of the relay server 3 determines whether the store SH is a store adopting a fixed coupon. This can be determined based on the store information set in the field F22 of the data record DR2 in the store database DB32 relating to the store SH.

If the store SH is a store adopting the fixed coupon, in ACT 3232, the processor 31 generates fixed coupon information based on the information concerning the fixed coupon set in the field F23. In contrast, if the store SH is a store adopting a variable coupon, in ACT 3232, the processor 31 refers to the charge table TB31 based on the charge table number set in the field F23 and generates, for example, variable coupon information based on a discount rate corresponding to the number of commodities purchased by the requester.

If the settlement completion notification is not received from the relay server 3 in ACT 601, in ACT 605, the processor 61 of the registration device 6 in a payment lane determines whether a new transaction is started. If coupon information is not included in the settlement completion notification in ACT 603 and after the coupon information is stored in ACT 604, the processor 61 proceeds to ACT 605. If determining in ACT 605 that a transaction is not started, the processor 61 proceeds to ACT 601.

The visitor proceeds to a predetermined checkout lane in the store SH in order to take out, from the shopping basket, the commodities that have been purchased by the requester through the settlement processing. At this time, one or more unpaid commodities to be purchased by the visitor himself or herself are also stored in the shopping basket.

If determining in ACT 605 that a transaction is started, in ACT 606, the processor 61 of the registration device 6 disposed in the checkout lane receives an input of member information of the visitor. The member information can be input by a store clerk reading, with the scanner 66, a barcode indicating a member number printed on a member card presented by the visitor or displayed on the touch panel 24 of the visitor terminal 2.

The processor 61 retrieves, using the input member information, a registrant code in the settlement completion list stored in the settlement-completion-list storing section ST61. In ACT 607, the processor 61 causes the touch panel 67 and the touch panel for customer 68 to display the settlement completion list.

Thereafter, in ACT 608, the processor 61 controls the scanner 66 to scan the commodities stored in the shopping basket. In ACT 609, the processor 61 determines whether a scanned commodity is already settled by the requester. The processor 61 can determine, according to whether the commodity is included in the retrieved settlement completion list, whether the scanned commodity has already been settled. If determining that the scanned commodity has not been settled, that is, the scanned commodity is a commodity that the visitor himself or herself purchases, in ACT 610, the processor 61 registers the commodity as a commodity to be purchased by the visitor.

Thereafter, or, if determining in ACT 609 that the scanned commodity is a settled commodity, in ACT 611, the processor 61 determines whether the subtotal key of the keyboard 65 is pressed. If the subtotal key is not pressed, the processor 61 proceeds to ACT 608.

If the subtotal key is pressed, in ACT 612, the processor 61 calculates a total amount of the registered commodities to be purchased by the visitor. Thereafter, in ACT 613, the processor 61 determines whether coupon information for the visitor is stored in the coupon-information storing section ST62. If the coupon information is stored, in ACT 614, the processor 61 applies a discount to the total amount based on the coupon information.

In ACT 615, the processor 61 performs settlement processing for those commodities to be purchased by the visitor. Thereafter, in ACT 616, the processor 61 controls the printer 610 to dispense receipts. In such a case, the processor 61 dispenses two receipts, that is, a receipt concerning the commodities purchased by the requester and a receipt concerning the commodities purchased by the visitor. For example, in response to a request for issuing an electronic receipt member from the requester, the processor may controls the communication unit 64 to transmit electronic receipt information to the electronic receipt server 7 instead of or in addition to the dispensing of the receipts by the printer 610.

In this way, if the visitor performs the settlement processing for commodities that the visitor has purchased by himself or herself, a coupon based on reward information can be applied to the transaction. That is, the reward information is instantaneously usable by the visitor.

As explained above, if the visitor does shopping for the visitor himself or herself in addition to the purchase for the requester, the visitor can immediately use the rewarded coupon. However, there is a case where the visitor does not do shopping for the visitor himself or herself. In order to cope with such a case, the reward information may be usable by the visitor in the future. That is, the visitor can use the coupon based on the reward information when the visitor visits the store SH next time.

FIG. 15 is a flowchart of information processing executed by the processor 61 of the registration device 6 that enables such a discount in the future.

The processing in ACT 601 to ACT 612 is as explained above. After calculating the total amount in ACT 612, in ACT 621, the processor 61 determines whether already acquired coupon information is usable. The processor 61 can determine whether the coupon information is usable by inquiring, via the communication unit 64, the relay server 3 about whether the coupon information is stored in the field F14 of the data record DR1 relating to the visitor in the member database DB31. Alternatively, the processor 61 may determine, according to whether the coupon information displayed on the touch panel 24 of the visitor terminal 2 is read by the scanner 66, whether the coupon information is usable. Since the settlement completion notification including the coupon information is transmitted from the relay server 3 to the visitor terminal 2 in ACT 324, by saving the settlement completion notification in the visitor terminal 2, the settlement completion notification can be displayed on the touch panel 24 in the visitor terminal 2.

If the coupon information is usable, in ACT 622, the processor 61 applies a discount to the total amount based on the coupon information. The processing in subsequent ACT 615 and ACT 616 is as explained above. After the receipts are dispensed in ACT 616, in ACT 613, the processor 61 determines whether coupon information for the visitor is stored in the coupon-information storing section ST62. If the coupon information is stored, in ACT 623, a coupon is issued. That is, the processor 61 controls the communication unit 64 to transmit the member number and the coupon information of the visitor to the relay server 3 to store the coupon information in the field F14 of the data record DR1 relating to the visitor in the member database DB31. Consequently, the visitor can use the coupon information when the visitor visits the store SH next time.

As explained above, the commodity purchase system in the aforementioned embodiments includes the visitor terminal 2, which is a portable terminal that is carried by the visitor visiting the store SH and reads code information of a commodity in the store SH, the relay server 3 that transmits commodity information corresponding to the code information read by the visitor terminal 2 to the requester terminal 1 operated by the requester, and the requester terminal 1 that displays the commodity information transmitted from the relay server 3 and transmits, to the visitor terminal 2, through the relay server 3, a purchase request for requesting the visitor to purchase the commodity indicated by the commodity information.

Accordingly, even if the requester is present in a place physically different from the store SH, the requester can see and choose to buy a commodity as if the requester is doing shopping in a store SH. If the visitor decided to deliver the commodity purchased by the requester, by granting a reward to the visitor, it is possible to reduce the number of deliveries by the store. Since a reward is obtained, the visitor gets motivated to deliver the purchased commodity himself or herself. The store SH can save labor and time for delivery arrangement. The reward information may be usable by the visitor immediately or in the future.

The commodity purchase system further includes the registration device 6 that performs registration processing and settlement processing for a commodity purchased by the visitor. With the commodity purchase system, reward information is output from the relay server 3 to the registration device 6. In the registration processing and the settlement processing concerning the commodity purchased by the visitor, the registration device 6 grants a reward based on the reward information output by the relay server 3.

Accordingly, if the visitor does shopping for the visitor himself or herself simultaneously with the commodity purchase for the requester, it is possible to cause the visitor to immediately use the reward. Consequently, since the visitor can immediately use the reward, it can be expected that the visitor gets motivated to deliver the commodity purchased for the requester.

The commodity purchase system further includes the registration device 6 that performs the registration processing and the settlement processing concerning the commodity purchased by the visitor. With the commodity purchase system, the reward information is output from the relay server 3 to the registration device 6. The registration device 6 issues a reward usable in the future based on the reward information output by the relay server 3.

Accordingly, by issuing a reward usable in the future for the visitor, even if the visitor has only a commodity purchased for the requester and does not do shopping for the visitor himself or herself, it is possible to motivate the visitor to deliver the commodity for the requester. By issuing the reward usable next time, it is possible to motivate the visitor to visit the store SH again in order to use the reward.

In the commodity purchase system, the registration device 6 displays the total payment amount output by the relay server 3 on the touch panel 67 and the touch panel for customer 68.

Accordingly, the store clerk and the visitor are capable of checking commodities that have been settled by the requester.

According to the aforementioned embodiments, the relay server 3 relays communication between the visitor terminal 2, which is the portable terminal carried by the visitor visiting the store SH, and the requester terminal 1 operated by the requester requesting the visitor to purchase a commodity. The relay server 3 receives code information of a commodity displayed in the store SH read by the visitor terminal 2 and transmits commodity information corresponding to the code information to the requester terminal 1. The relay server 3 transmits, to the visitor terminal 2, a purchase request for requesting purchase of a commodity indicated by the commodity information transmitted from the requester terminal 1. The relay server 3 inquires, in response to a settlement request transmitted from the requester terminal 1, the visitor terminal 2 about whether a commodity purchased by the requester is delivered by the visitor or the store SH. The relay server 3 calculates, according to a selection result of the delivery method transmitted from the visitor terminal 2, a total payment amount of the commodity purchased by the requester and performs settlement processing based on the amount and a settlement method set for the requester. If the delivery method selected by the visitor terminal 2 is delivery by the visitor, the relay server 3 generates reward information for the visitor. The relay server 3 outputs settlement information including the total payment amount and the reward information to the registration device 6.

Accordingly, even if the requester is present in a place physically different from the store SH, the requester can see and choose to buy a commodity as if the requester is doing shopping in the store SH. If the visitor decides to deliver the commodity purchased by the requester, the relay server 3 grants a reward to the visitor. Consequently, the visitor is motivated to deliver the purchased commodity for the requester. It is possible to increase a chance that the visitor delivers the commodity. As a result, the store SH can save labor and time for delivery arrangement. The reward may be instantaneously usable by the visitor or may be stored for the visitor's future use.

According to the aforementioned embodiments, the registration device 6 receives, from the relay server 3, which performs settlement processing for a commodity to be purchased by the requester based on a settlement method set for the requester, settlement information including at least the payment amount of the commodity purchased by the requester. If registration processing and settlement processing for a commodity to be purchased by the visitor are performed and if the settlement information further includes reward information for the visitor, the registration device 6 grants a reward based on the reward information. The reward information is included in the settlement information only if the visitor chooses to deliver the commodity settled by the requester.

Various modifications to the aforementioned embodiments are possible.

A part or all of the functions performed by the processors 11, 21, 31, and 61 according to the information processing can also be performed by hardware such as one or more logic circuits. Each of the functions can also be performed by a combination of software and hardware such as logic circuits.

The order of the processing in ACT 322 and the processing in ACT 323 may be changed.

By using the existing image recognition technique, the processor 31 of the relay server 3 may recognize commodities in an image photographed by the camera 25 of the visitor terminal 2 and generate video data for superimposing and displaying, on a streaming video that the processor 31 causes the touch panel 14 of the requester terminal 1 to display, commodity information of a commodity reflected in the streaming video. Consequently, if the requester designates a desired commodity, the processor 31 of the relay server 3 can transmit commodity information of the commodity to the visitor terminal 2 and cause the touch panel 24 to display the commodity information. Therefore, the processor 31 can surely notifies the visitor of the desired commodity.

Although not previously illustrated and explained, at any point in time before settlement is performed, according to a request from the requester terminal 1 or the visitor terminal 2, a commodity registered as a requester-purchased commodity stored in the data record DR3 in the transaction management database DB33 may be able to be checked. By checking the commodity, the requester can request the visitor to increase or reduce the quantity of the commodity or cancel the commodity. The visitor can check matching of a commodity to be purchased by the requester put in a shopping basket and a registration result and, if the commodity to be purchased and the registration result do not coincide, adjust the commodity in the shopping basket to coincide with the registration result.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A commodity purchase system for assisting a customer who is not at a store in making purchase, the system comprising:
a first terminal configured to capture an image of one or more commodities displayed in a store;
a relay server configured to acquire commodity information about one of the commodities in the image; and
a second terminal configured to:
display the commodity information and issue a purchase request for purchase of said one of the commodities for a customer, and
issue a settlement request for settling a purchase of one or more commodities being purchased by the customer, wherein
the relay server is further configured to:
upon issuance of the settlement request, cause the first terminal to output a screen through which a delivery method of the purchased commodities can be selected,
calculate a payment amount of the purchased commodities and a reward for a user of the first terminal based on a selection result of the delivery method, and
perform settlement processing on the purchased commodities based on the calculated payment amount and output reward information indicating the calculated reward.

2. The commodity purchase system according to claim 1, wherein the delivery method is a first delivery method in which delivery of the commodities purchased by the customer is arranged by the user of the first terminal or a second delivery method in which the delivery is arranged by the store.

3. The commodity purchase system according to claim 2, wherein the reward is granted to the user of the first terminal when the first delivery method is selected.

4. The commodity purchase system according to claim 1, wherein the reward information is output to an external device.

5. The commodity purchase system according to claim 1, further comprising:
a registration device configured to acquire the reward information and apply the reward to settlement of one or more commodities purchased by the user of the first terminal separately from the commodities purchased by the requester.

6. The commodity purchase system according to claim 5, wherein the registration device is further configured to, based on the reward information, issue a coupon that allows the reward to be applied to future settlement for the user of the first terminal.

7. The commodity purchase system according to claim 5, wherein
the relay server is further configured to output the calculated payment amount to the registration device, and
the registration device is further configured to display the calculated payment amount.

8. The commodity purchase system according to claim 1, wherein the image is continuously captured and streamed to the second terminal via the relay server.

9. The commodity purchase system according to claim 1, wherein the relay server is further configured to register said one of the commodities for the customer's purchase in response to the purchase request from the second terminal.

10. The commodity purchase system according to claim 1, wherein the reward varies depending on a total number of the commodities purchased by the customer.

11. A relay server in a commodity purchase system for assisting a customer who is not at a store in making purchase, the relay server comprising:
a network interface configured to communicate with:
a first terminal configured to capture an image of one or more commodities displayed in a store, and
a second terminal configured to display commodity information about one of the commodities and issue a purchase request for purchase of said one of the commodities for a customer; and
a processor configured to:
acquire the commodity information about said one of the commodities of the image and control the network interface to output the commodity information to the second terminal,
upon issuance of a settlement request for settling purchase of one or more commodities purchased by the customer, cause the first terminal to output a screen through which a delivery method of the purchased commodities can be selected,
calculate a payment amount of the purchased commodities and a reward for a user of the first terminal based on a selection result of the delivery method, and
perform settlement processing on the purchased commodities based on the calculated payment amount and control the network interface to output reward information indicating the calculated reward.

12. The relay server according to claim 11, wherein the delivery method is a first delivery method in which delivery of the commodities purchased by the customer is arranged by the user of the first terminal or a second delivery method in which the delivery is arranged by the store.

13. The relay server according to claim 12, wherein the reward is granted to the user of the first terminal when the first delivery method is selected.

14. The relay server according to claim 11, wherein the reward information is output to a registration device installed in the store.

15. The relay server according to claim 14, wherein the reward is, by the registration device, applied to settlement of one or more commodities purchased by the user of the first terminal separately from the commodities purchased by the requester.

16. The relay server according to claim 15, wherein a coupon is issued based on the reward information such that the reward is applied to future settlement for the user of the first terminal.

17. The relay server according to claim 15, wherein
the processor is further configured to control the network interface to output the calculated payment amount to the registration device and cause the registration device to display the calculated payment amount.

18. The relay server according to claim 11, wherein the processor is further configured to stream the image continuously captured by the first terminal to the second terminal.

19. The relay server according to claim 11, wherein the processor is further configured to register said one of the commodities for the customer's purchase in response to the purchase request from the second terminal.

20. A registration device in a commodity purchase system for assisting a customer who is not at a store in making a purchase, the commodity purchase system including a relay server, a first terminal used by a first customer and configured to capture an image of one or more commodities displayed in the store, and a second terminal used by a second customer and configured to display commodity information about one of the commodities and issue a purchase request for purchase of said one of the commodities, the registration device comprising:
a network interface configured to communicate with the relay server; and
a processor configured to:
upon receipt of settlement information about one or more commodities that have been purchased by the second customer, acquire reward information indicated a reward that is granted to the first customer based on a delivery method of the commodities, and
perform settlement processing on one or more commodities purchased by the first customer, the reward being applicable to the settlement processing.
